(19) United States
(12) Patent Application Publication
(10) Pub. No.: US 2016/0043656 A1
(43) Pub. Date: Feb. 11, 2016

(54) POWER-TYPE VOLTAGE-MULTIPLYING DRIVING CIRCUIT AND ELECTRIC NAIL GUN USING POWER-TYPE VOLTAGE-MULTIPLYING DRIVING CIRCUIT

(71) Applicant: BEIJING DAFENG TECHNOLOGY LTD., Beijing (CN)

(72) Inventors: Zhiwen LIAO, Beijing (CN); Yue FAN, Beijing (CN); Zezhou FENG, Beijing (CN)

(73) Assignee: BEIJING DAFENG TECHNOLOGY LTD., Beijing (CN)

(21) Appl. No.: 14/761,870

(22) PCT Filed: Dec. 27, 2013
(86) PCT No.: PCT/CN2013/090678

§ 371 Date: Nov. 2, 2015

(30) Foreign Application Priority Data
Jan. 17, 2013 (CN) 201310017935.6

(51) Int. Cl. H02M 7/19; B25C 1/06

(52) U.S. Cl. CPC H02M 7/19; B25C 1/06

(57) ABSTRACT

With respect to a defect that a large-size capacitor is required to implement voltage multiplication in the prior art, the present invention provides a power-type voltage-multiplying driving circuit capable of overcoming the defect. An alternating current power supply J1, a unidirectional conducting element D1, and a charge storing element C are connected in series to form a charging circuit for charging the charge storing element C. A parallel circuit formed by the charge storing element C and the unidirectional conducting element D3 is connected in series to the alternating current power supply J1, a load R, and a switch element SCR to form a load driving circuit for performing voltage multiplication driving on the load R. A control unit KZ detects the voltage of the alternating current power supply J1 and controls, based on the detected voltage, ON and OFF of the switch element SCR, so as to perform voltage multiplication driving on the load R by means of the mutual cooperation between the control unit KZ, the alternating current power supply J1, the charge storing element C, and the switch element SCR after the unidirectional conducting element D1 charges the charge storing element C, the voltage driving the load R being adjusted between 1 and 2 times of the peak voltage of the alternating current power supply J1.

### TECHNICAL FIELD

The present invention relates to electric and electronic field, in particular to a power-type voltage-multiplying driving circuit and an electric nail gun that utilizes the power-type voltage-multiplying driving circuit.

### BACKGROUND

In occasions where an electric appliance has to be driven at a quick-pulse voltage higher than the voltage of AC power supply, usually the required driving voltage is obtained by means of a capacitor voltage-multiplying technique.

A conventional capacitor voltage-multiplying circuit mainly utilizes AC or pulsed power supply combined with capacitors via rectifying elements to charge the capacitors and thereby create a DC voltage across the capacitors that is several times of the peak voltage of the AC or pulsed power supply, so as to drive a load.

However, in such a conventional capacitor voltage-multiplying circuit, the number of capacitors in the energy storing capacitors is higher than the multiple of voltage-multiplying, and withstand voltage of the capacitors must be higher than 2 times of voltage peak of the AC power supply. Hence, large-size capacitors have to be used to meet the requirement of the voltage-multiplying circuit in occasions where high driving power is required. Thus, on one hand, the size of capacitors in the conventional capacitor voltage-multiplying circuit will be increased, and thereby the size of the conventional capacitor voltage-multiplying circuit will be increased accordingly; on the other hand, the cost of the capacitor voltage-multiplying circuit will be increased.

### SUMMARY

In view of the drawback that large-size capacitors have to be used in conventional capacitor voltage-multiplying circuits in the prior art, the present invention provides a power-type voltage-multiplying driving circuit that overcomes the drawback and an electric nail gun that utilizes the power-type voltage-multiplying driving circuit.

The present invention provides a power-type voltage-multiplying driving circuit, comprising: a charging circuit, formed by connecting an AC power supply J1, a unidirectional conducting element D1, and a charge storing element C connected in series, and configured to charge the charge storing element C; a load driving circuit, formed by connecting a parallel circuit with the AC power supply J1, a load R, and a switching element SCR in series, configured to drive the load R by voltage-multiplication, wherein the parallel circuit including the charge storing element C and a unidirectional conducting element D3 connected in parallel; and a control unit KZ, configured to detect voltage of the AC power supply J1 and control ON/OFF of the switching element SCR on the basis of the detected voltage, such that the control unit KZ, the AC power supply J1, the charge storing element C, and the switching element SCR will work together to drive the load R by voltage multiplication after the charge storing element C is charged via the unidirectional conducting element D1, wherein the driving voltage for the load R can be adjusted within 1 time to 2 times of the peak voltage of the AC power supply J1.

The present invention further provides an electric nail gun that utilizes the power-type voltage-multiplying driving circuit described above.

Since the power-type voltage-multiplying driving circuit according to the present invention charges the charge storing element C in the positive (or negative) half cycle of the AC power supply J1 and utilizes the sum of the voltage of the AC power supply J1 and the voltage of the charge storing element C to drive the load R in the follow-up negative (or positive) half cycle, the required withstand voltage level of the charge storing element C can be greatly decreased, and thereby the size of the charge storing element C can be decreased greatly, and accordingly the cost and size of the power-type voltage-multiplying driving circuit and electric nail gun according to the present invention can be decreased.

### BRIEF DESCRIPTION OF THE DRAWINGS

The accompanying drawings are provided here to facilitate further understanding on the present invention, and constitute a part of this document. They are used in conjunction with the following embodiments to explain the present invention, but shall not be comprehended as constituting any limitation to the present invention. Among the drawings:

FIG. 1 is a circuit diagram of the power-type voltage-multiplying driving circuit according to an embodiment of the present invention;

FIG. 2 is a circuit diagram of the power-type voltage-multiplying driving circuit according to another embodiment of the present invention;

FIG. 3 is a curve diagram of the voltage of power supply and the operating voltage and operating current of the loop when an electric nail gun is driven at 120V AC voltage, without utilizing the power-type voltage-multiplying driving circuit according to the present invention; and

FIG. 4 is a curve diagram of the voltage of power supply and the operating voltage and operating current of the loop when an electric nail gun is driven at 120V AC voltage with the power-type voltage-multiplying driving circuit according to the present invention.

### DETAILED DESCRIPTION

Hereunder the embodiments of the present invention will be detailed, with reference to the accompanying drawings. It should be appreciated that the embodiments described here are only provided to describe and explain the present invention, but shall not be deemed as constituting any limitation to the present invention.

It should be noted: unless otherwise specified, term “control unit”, when mentioned in the following text, refers to a controller that can output control instructions (e.g., pulse waveforms) under predefined conditions or at preset times to control ON or OFF of a switching element connected with it, for example, the control unit can be a PLC, a single-chip unit, or an adjustable resistive-capacitive delay controller, etc. When mentioned in the following text, term “switching element” refers to a switch that turns ON/OFF according to electrical signals or on the basis of characteristics of the element, and can be a unidirectional switch (e.g., a switch that is composed of a bidirectional switch and a diode connected in series and can switch on or off in one direction only) or a bidirectional switch (e.g., a Metal Oxide Semiconductor Field Effect Transistor, MOSFET, or an IGBT or a silicon controlled switch with an anti-parallel flywheel diode. When mentioned in the following text, term “unidirectional conducting element” refers to a semiconductor element that turns ON/OFF in response to electrical signals or characteristics of the element so that electric current can flow therein in one direction only. When mentioned in the following text, term “charge storing element” refers to a device that supports charge storage, such as a capacitor, etc.

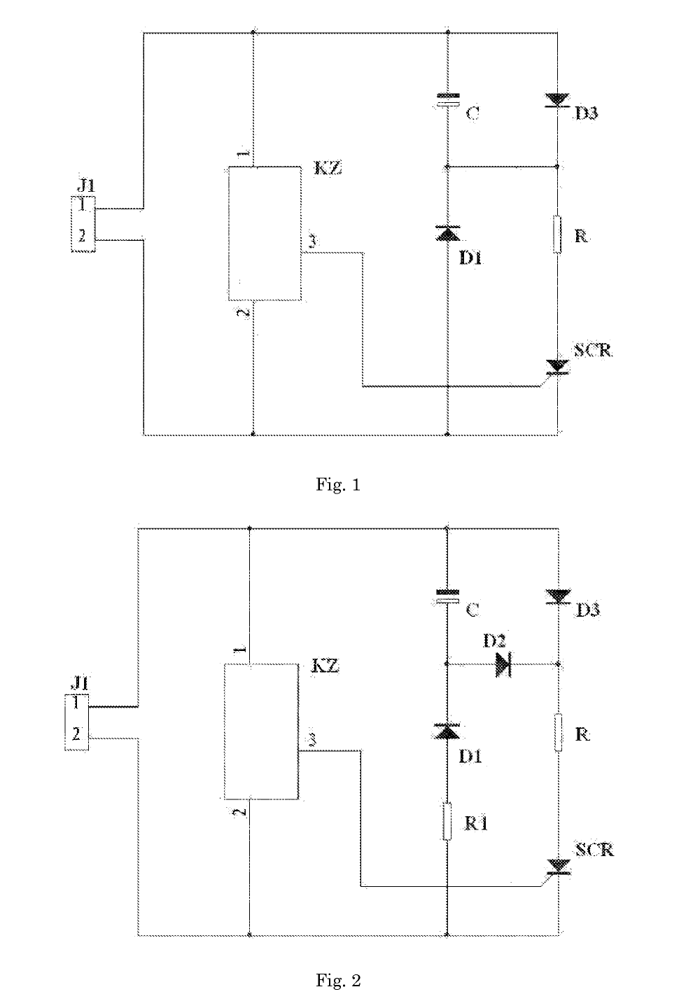

FIG. 1 is a schematic circuit diagram of the power-type voltage-multiplying driving circuit according to an embodiment of the present invention. As shown in FIG. 1, in the power-type voltage-multiplying driving circuit according to the embodiment, an AC power supply J1, a unidirectional conducting element D1, and a charge storing element C are connected in series to form a charging circuit that charges the charge storing element C; a parallel circuit composed of the charge storing element C and a unidirectional conducting element D3 is connected with the AC power supply J1, a load R, and a switching element SCR in series to form a load driving circuit that drives the load R by voltage multiplication; and a control unit KZ is configured to detect voltage of the AC power supply J1 and control ON and OFF of the switching element SCR according to the detected voltage, so that the control unit KZ, the AC power supply J1, the charge storing element C, and the switching element SCR work together to drive the load R by voltage multiplication after the charge storing element C is charged via the unidirectional conducting element D1, wherein voltage for driving the load R can be regulated between 1 time and 2 times of the peak voltage of the AC power supply J1.

Wherein the unidirectional conducting element D1 and unidirectional conducting element D3 can be unidirectional conducting elements that turn ON/OFF on the basis of their own characteristics, such as diodes, or can be unidirectional conducting elements that turn ON/OFF in response to electrical signals, such as Silicon Unidirectional Switches (SUSes), or elements that turn ON/OFF in response to electrical signals so that the electric current flows in them in one direction only, such as MOSFETs, etc. In addition, in a case that the unidirectional conducting elements D1 and D3 are switching elements that turn ON/OFF control on the basis of electrical signals (e.g., SUSes, MOSFETs, etc.), their ON/OFF can be controlled by the control unit KZ. The switching element SCR can be any of silicon controlled switch, MOSFET, and IGBT. The charge storing element C can be any capacitor that can store charges, such as an electrolytic capacitor. The control unit KZ can be a single-chip, a PLC, or an adjustable resistive-capacitive delay controller, etc.

The operating principle of the power-type voltage-multiplying driving circuit shown in FIG. 1 is as follows: when the AC power supply J1 charges the charge storing element C in a negative half cycle, the unidirectional conducting element D1 is on, and the control unit KZ controls the switching element SCR to keep it in OFF state, and, at this point, there is no current flow in the load R; when the control unit KZ controls the switching element SCR to switch on at a voltage Uk in a subsequent positive half cycle of the AC power supply J1 in response to an external control instruction or on the basis of the internal setting of the control unit KZ, the voltage applied across the load R is equal to the sum of the voltage of the charge storing element C and the voltage Uk of the AC power supply J1.

It is seen from the above analysis of operating principle, the withstand voltage level of the charge storing element C in the power-type voltage-multiplying driving circuit according to the present invention can be decreased to a half of the withstand voltage level of the capacitors used in the conventional capacitor voltage-multiplying driving technique; hence, theoretically the size of the charge storing element C is only ¼ of a capacitor that implements the same function in the conventional capacitor voltage-multiplying driving technique; thus, the size of the charge storing element C in the power-type voltage-multiplying driving circuit according to the present invention is decreased, and thereby the cost and size of the power-type voltage-multiplying driving circuit according to the present invention are decreased, and the portability of the power-type voltage-multiplying driving circuit according to the present invention is increased.

Moreover, with the combination of the control unit KZ and the switching element SCR, the driving voltage for the load R can be adjusted freely within 1˜2 times of the peak voltage of the AC power supply J1, i.e., first, the voltage of the AC power supply J1 required for the control unit KZ to switch on the switching element SCR is set in the control unit KZ; then, when the power-type voltage-multiplying driving circuit provided in the present invention operates, the control unit KZ will detect the voltage of the AC power supply J1, and will control the switching element SCR to switch on when the detected voltage is equal to a set value in the control unit KZ, and thereby the load R is driven. If the control unit KZ is set to control the switching element SCR to switch on at the peak voltage of the AC power supply J1, the instantaneous voltage applied across the load R when the switching element SCR switches on is equal to 2 times of the peak voltage of the AC power supply J1.

Furthermore, it should be noted: a polar electrolytic capacitor may be broken down and thereby damaged if it is charged in the reverse direction, since the dielectric properties of the polar electrolytic capacitor are poor in the reverse direction, which is well-known. Hence, in a case that the charge storing element C in FIG. 1 is a polar electrolytic capacitor, the unidirectional conducting element D3 will be switched off before the charges in the charge storing element C are discharged completely and will be switched on after the charges in the charge storing element C are discharged completely, in order to avoid reverse charging from the AC power supply J1 to the charge storing element C and resultant breakdown of the charge storing element C.

FIG. 2 is a circuit diagram of the power-type voltage-multiplying driving circuit according to another embodiment of the present invention. As shown in FIG. 2, a unidirectional conducting element D2 is added in this embodiment, as compared with the embodiment shown in FIG. 1, wherein a series circuit composed of the unidirectional conducting element D2 and the charge storing element C is connected with the unidirectional conducting element D3 in parallel. The unidirectional conducting element D2 is identical to the unidirectional conducting element D3, and is provided to compensate for the voltage drop resulted from the switching of the unidirectional conducting element D3 to ON state in the positive direction, and thereby to prevent the charge storing element C from charged and broken down in the reverse direction.

The unidirectional conducting element D2 shown in FIG. 2 can be a unidirectional conducting element that turns ON/OFF on the basis of its own characteristics, such as diodes, or can be a unidirectional conducting element that turns ON/OFF in response to electrical signals, such as Silicon Unidirectional Switches (SUSes), or element that turns ON/OFF in response to electrical signals so that the electric current flows in it in one direction only, such as MOSFETs, etc. In addition, in a case that the unidirectional conducting element D2 is a switching element that turns ON/OFF in response to electrical signals (e.g., SUS, MOSFET, etc.), the ON/OFF of the unidirectional conducting element D2 can be controlled by the control unit KZ.

The operating principle of the power-type voltage-multiplying driving circuit shown in FIG. 2 is as follows:

When the charge storing element C is charged by the AC power supply J1 in a negative half cycle in which the unidirectional conducting element D1 is in ON state, the control unit KZ control the switching element SCR to keep the switching element SCR in OFF state; at this point, there is no current flow in the load R, and the unidirectional conducting element D2 and the unidirectional conducting element D3 are in OFF state.

When the control unit KZ controls the switching element SCR to switch on at a voltage Uk in a follow-up positive half cycle of the AC power supply J1 in response to an external control instruction or on the basis of the internal setting of the control unit KZ, if the charges in the charge storing element C have not been discharged completely, the unidirectional conducting element D3 will be in OFF state, and the charge storing element C will discharge to the load R through a loop composed of the unidirectional conducting element D2, AC power supply J1, switching element SCR, load R and the charge storing element C. Whereas, the unidirectional conducting element D3 will be in ON state if the charges in the charge storing element C have been discharged completely, and, in that state, the AC power supply J1 supplies power to the load R via the unidirectional conducting element D3, since both the unidirectional conducting elements D2 and the unidirectional conducting element D3 are connected with the load R in series respectively. At the same time, the AC power supply J1 also supplies power to the load R through the loop composed of the unidirectional conducting element D2, AC power supply J1, switching element SCR, load R, and charge storing element C. Here, the charge storing element C is not charged in the reverse direction, since the voltage drop across the unidirectional conducting element D2 is equal to that across the unidirectional conducting element D3, thus a purpose of protecting the charge storing element C and prolonging its service life is attained. In addition, in a case that the unidirectional conducting elements D2 and D3 are diodes, they will be in ON state in that half cycle, owing to their intrinsic characteristics. If the unidirectional conducting elements D2 and D3 are unidirectional conducting elements that turn ON/OFF in response to electrical signals, their ON/OFF can be controlled by the control unit KZ or another control unit (not shown), so that the unidirectional conducting element D2, unidirectional conducting element D3, and switching element SCR are switched on simultaneously, and thereby the load R is driven by voltage-multiplication. Here, the voltage applied across the load R is equal to the sum of the voltage of the charge storing element C and the voltage Uk of the AC power supply J1,thus the load R is also driven by voltage-multiplication.

Furthermore, a polar electrolytic capacitor may be broken down and thereby damaged if it is charged in the reverse direction, since the dielectric properties of the polar electrolytic capacitor are poor in the reverse direction, which is well-known. Hence, it is seen from the analysis of the operating principle shown in FIG. 2, in a case that the charge storing element C is a polar electrolytic capacitor, the circuit composed of the unidirectional conducting element D2 and the unidirectional conducting element D3 can avoid reverse breakdown of the charge storing element C by the AC power supply J1.

Hereunder the circuit diagram shown in FIG. 2 will be further detailed, in an example that both the unidirectional conducting element D2 and the unidirectional conducting element D3 shown in FIG. 2 are diodes. When the potential at the terminal 2 of the AC power supply J1 is higher than that at the terminal 1 of the AC power supply J1, the charge storing element C will be charged, and the control unit KZ will control the switching element SCR to keep the switching element SCR in OFF state; whereas, when the potential at the terminal 2 of the AC power supply J1 is lower than that at the terminal 1, in the period that the control unit KZ controls the switching element SCR to switch on at a specific voltage of the AC power supply J1 and thereby drives the load R in response to an external control instruction or on the basis of the inner setting of the control unit KZ, the unidirectional conducting element D2 is in ON state (wherein the unidirectional conducting element D3 is in OFF state before the charges in the charge storing element C are discharged completely); in that period, if the charges charged into the charge storing element C in the previous half cycle have been discharged completely, the charge storing element C will not be broken down in the reverse direction even though the potential at the terminal 2 of the AC power supply J1 is lower than that at the terminal 1, owing to the bypass effect of the unidirectional conducting element D3 and the equal voltage drop across the unidirectional conducting elements D2 and D3. In that way, a purpose of protecting the charge storing element C and prolonging the service life of the charge storing element C is attained, which is very important in a case that the charge storing element C is composed of high-capacity and small-size polar electrolytic capacitors. Compared with non-polar charge storing elements, polar electrolytic capacitors are more favorable for size and cost reduction.

In addition, as shown in FIG. 2, the power-type voltage-multiplying driving circuit according to the present invention may further comprise a resistor R1 connected in series in the charging circuit to limit the charging current when the charge storing element C is charged.

Moreover, though the load R as shown in FIG. 1 and FIG. 2 is a resistor, it should be appreciated that the power-type voltage-multiplying driving circuit according to the present invention can be used to drive other loads, such as inductive loads, arc loads, and combined resistive-capacitive-inductive loads, besides resistive loads, so as to drive electromagnetic valves, electromagnets, and instantaneous heating devices, etc.

In addition, it should be noted: though all the unidirectional conducting elements D1, D2, and D3 as shown in the accompanying drawings are diodes, those skilled in the art can envisage that the object of the present invention can also be attained by means of bidirectional switches, as long as proper sequential control is applied. For example, in a case that the unidirectional conducting element D1 is a MOSFET transistor that has bidirectional conductibility, the object of charging the charge storing element C in the negative (or positive) half cycles of the AC power supply J1 and utilizing the sum of the voltage of the charge storing element C and the voltage of the AC power supply J1 to drive the load R in the positive (or negative) half cycles can also be attained.

Hereunder the beneficial effects of the power-type voltage-multiplying driving circuit according to the present invention will be described exemplarily in an application of the power-type voltage-multiplying driving circuit in a lever-type electromagnetic nail gun.

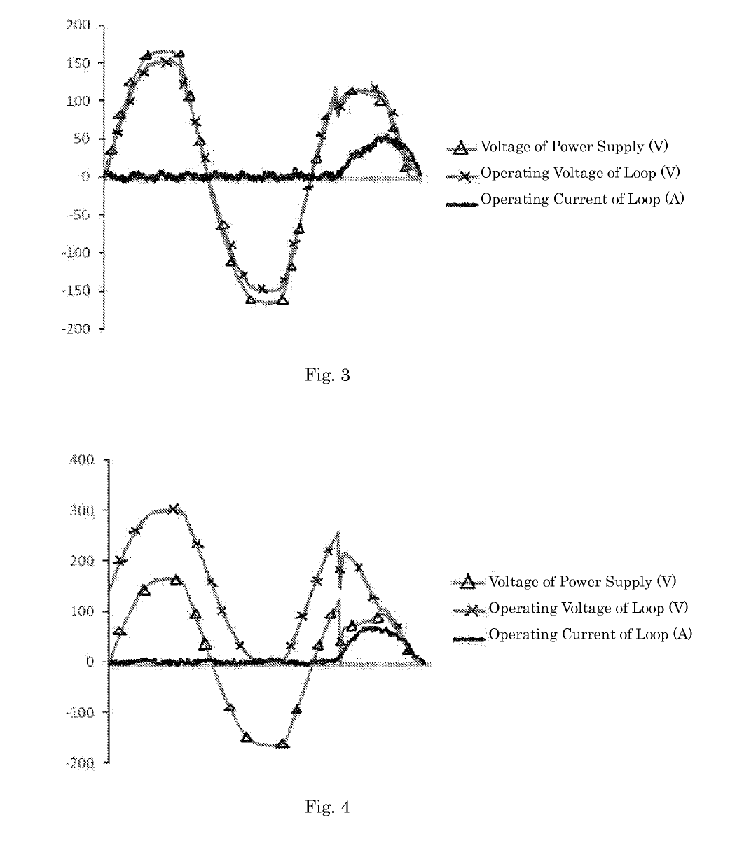

When a lever-type electromagnetic nail gun operates, the loop of the gun must be driven at a high operating voltage (e.g., 220V), in order to obtain high operating current in the loop (higher than 70 A). When the lever-type electromagnetic nail gun is driven by 120V power supply, the driving power is inadequate, and the operating current in the loop can be up to 50 A only, as indicated by the measured curve in FIG. 3.

In contrast, when the power-type voltage-multiplying driving circuit according to the present invention is applied in a lever-type electromagnetic nail gun, 70 A loop operating current can still be obtained at 120 VAC power supply. As demonstrated by the measured curve in FIG. 4, the peak value of driving voltage in FIG. 4 is about 1 time of that in FIG. 3, while the driving current is about 1.5 times of that in FIG. 3. Moreover, it should be noted that the supply voltage as shown in FIG. 3 and FIG. 4 is the measured voltage at the power outlet connected to the electric nail gun, and it is not the theoretical sinusoidal wave owing to the disturbance from the operation of the electric nail gun.

Though the present invention is detailed above in some preferred embodiments of the present invention, it should be appreciated that various modifications and variations can be made to the present invention, without departing from the spirit and scope of the present invention.

1. A power-type voltage-multiplying driving circuit, comprising:
a charging circuit, formed by connecting an AC power supply J1, a unidirectional conducting element D1, and a charge storing element C connected in series, and configured to charge the charge storing element C;
a load driving circuit, formed by connecting a parallel circuit with the AC power supply J1, a load R, and a switching element SCR in series, configured to drive the load R by voltage-multiplication, wherein the parallel circuit including the charge storing element C and a unidirectional conducting element D3 connected in parallel; and
a control unit KZ, configured to detect voltage of the AC power supply J1 and control ON/OFF of the switching element SCR on the basis of the detected voltage, such that the control unit KZ, the AC power supply J1, the charge storing element C, and the switching element SCR will work together to drive the load R by voltage multiplication after the charge storing element C is charged via the unidirectional conducting element D1, wherein the driving voltage for the load R can be adjusted within 1 time to 2 times of the peak voltage of the AC power supply J1.

2. The power-type voltage-multiplying driving circuit according to claim 1, wherein the unidirectional conducting element D1 and unidirectional conducting element D3 are unidirectional conducting elements that turn ON/OFF on the basis of their own characteristics or switching elements that turn ON/OFF in response to electrical signals.

3. The power-type voltage-multiplying driving circuit according to claim 1, further comprising a resistor R1 that is connected in series in the charging circuit to limit the charging current.

4. The power-type voltage-multiplying driving circuit according to claim 1, wherein the switching element SCR can be any of silicon controlled switch, MOSFET, and IGBT.

5. The power-type voltage-multiplying driving circuit according to claim 1, wherein the control unit KZ is any controller that can output control instructions under predefined conditions or at preset times so as to control the switching element SCR to switch on or off accordingly.

6. The power-type voltage-multiplying driving circuit according to claim 5, wherein the control unit KZ is any of PLC, single-chip unit, and adjustable resistive-capacitive delay controller.

7. The power-type voltage-multiplying driving circuit according to claim 1, wherein the charge storing element C is any capacitor that can stores charges.

8. The power-type voltage-multiplying driving circuit according to any of claims 1-7, further comprising a unidirectional conducting element D2, a series circuit is connected with the unidirectional conducting element D3 in parallel, so as to prevent the charge storing element C from charged or broken down in the reversed direction in the case that the charge storing element C is a polar electrolytic capacitor, wherein the series circuit including the unidirectional conducting element D2 and the charge storing element C connected in series.

9. The power-type voltage-multiplying driving circuit according to claim 8, wherein, the unidirectional conducting element D2 is a unidirectional conducting element that turns ON/OFF on the basis of its own characteristics or a switching element that turns ON/OFF in response to electrical signals.

10. An electric nail gun that utilizes the power-type voltage-multiplying driving circuit as set forth in any of claims 1-9.
